(19) United States
(12) Patent Application Publication
(10) Pub. No.: US 2009/0158221 A1
(43) Pub. Date: Jun. 18, 2009

(54) DEVICE FEATURE MANIPULATION BASED ON PRESENTED CONTENT

(75) Inventors: Peter Dam Nielsen, Kgs Lyngby (DK); Christian Rossing Kraft, Frederiksberg (DK)

Correspondence Address: PERMAN & GREEN, 425 POST ROAD, FAIRFIELD, CT, 06824, US

(73) Assignee: NOKIA CORPORATION

(21) Appl. No.: 11/957,966

(22) Filed: Dec. 17, 2007

(51) Int. Cl. G06F 3/048

(52) U.S. Cl. 715/867

(57) ABSTRACT

A method including automatically determining one or more characteristics of displayed content and dynamically adjusting a timeout period in dependence on the one or more characteristics.

### BACKGROUND

1. Field

The disclosed embodiments generally relate to user interfaces and, more particularly, to managing light sources of devices.

2. Brief Description of Related Developments

Generally power consumption of mobile devices is an increasingly important issue. Power management in mobile devices extends battery life and decreases the amount of time necessary to recharge the batteries of the mobile devices. Although the power consumed by one mobile device when recharging its batteries is not that great, when the number of mobile devices in existence is considered, a large amount of power is consumed when recharging these devices. This large amount of power consumption increases the demand for power generation that, in turn, increases fuel consumption and the amount of pollutants that are introduced into the atmosphere. This increase in fuel consumption and atmospheric pollutants reduces natural resources and compounds global warming problems.

It would be advantageous to provide a power management scheme in mobile devices to reduce the amount of power consumed by the mobile devices.

### SUMMARY

In one aspect, the disclosed embodiments are directed to a method. In one embodiment the method includes automatically determining one or more characteristics of displayed content and dynamically adjusting a timeout period in dependence on the one or more characteristics.

In another aspect, the disclosed embodiments are directed to an apparatus. In one embodiment the apparatus includes a processor and a display connected to the processor, wherein the processor is configured to automatically determine one or more characteristics content presented on the display and dynamically adjust a timeout period in dependence on the one or more characteristics.

In another aspect, the disclosed embodiments are directed to a user interface. The user interface includes an input device, a display and a processor connected to the input and display, the processor being configured to automatically determine one or more characteristics content presented on the display and dynamically adjust a timeout period in dependence on the one or more characteristics.

### BRIEF DESCRIPTION OF THE DRAWINGS

The foregoing aspects and other features of the embodiments are explained in the following description, taken in connection with the accompanying drawings, wherein:

FIG. 1 shows a block diagram of a device in which aspects of the disclosed embodiments may be applied;

FIG. 2 illustrates a flow diagram in accordance with an aspect of the disclosed embodiments;

FIGS. 3A-3C, 4 and 5 are illustrations of exemplary screen shots of a user interface in accordance with the disclosed embodiments;

FIGS. 6A and 6B are illustrations of examples of devices that can be used to practice aspects of the disclosed embodiments;

FIG. 7 illustrates a block diagram of an exemplary system incorporating features that may be used to practice aspects of the disclosed embodiments; and

FIG. 8 is a block diagram illustrating the general architecture of an exemplary system in which the exemplary devices of FIGS. 6A and 6B may be used.

### DETAILED DESCRIPTION OF THE EMBODIMENT(S)

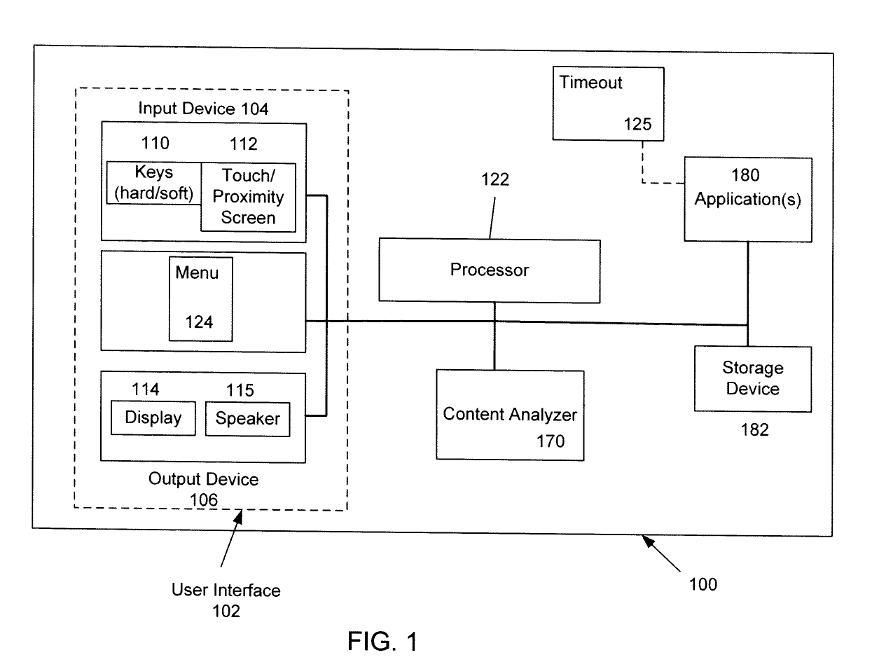

FIG. 1 illustrates a block diagram of a device 100 in which aspects of the disclosed embodiments can be used. Although aspects of the disclosed embodiments will be described with reference to the embodiments shown in the drawings and described below, it should be understood that these aspects could be embodied in many alternate forms. In addition, any suitable size, shape or type of elements or materials could be used.

The disclosed embodiments provide for power management in any suitable device 100. In general the disclosed embodiments provide the dynamic management of any suitable light emitting display. The disclosed embodiments provide a dynamic light timeout 125 that is dependent on a user's ability to understand displayed content. The device may be configured to automatically account for the user's ability by determining one or more content features presented on a display 114 of the device 100. The content features determined by the device 100 can be any suitable features including, but not limited to, text characteristics (e.g. number of characters, length of words, complexity of text, text density, a readability index, font size, type and color, etc.), still or moving image characteristics (e.g. colors, brightness, contrast, image details, etc.) and display characteristics (e.g. active pixels, colors, etc.) as will be described in greater detail below. The device 101 is configured to calculate the light timeout 125 based on the determined display features. The dynamic light timeout 125 allows power management of the mobile device while allowing a user adequate time to view display contents before an intensity of the display light (hereinafter the “display”) is changed (e.g. reduced in power/dimmed or turned off).

Generally, in the disclosed embodiments the length of light timeout 125 is automatically adjusted depending on determined display content features. As one example, a text message having 160 characters will have a longer light timeout than a text message having 50 characters. As the light timeout 125 is automatically adjusted, the disclosed embodiments as described herein may extend battery life and reduce the power consumed by the device 100. The decreased power consumption may extend the time between battery charges.

The disclosed embodiments can also control other elements of the user interface such as a length of time before pop-up windows appear on the display 114 or a length of time information is displayed before it is removed from the display 114. In controlling other elements of the user interface one or more of the display item content features as described above are considered when determining the time periods for presenting the display information before the displayed information changes.

The disclosed embodiments provide a sufficient amount of time for a user to comprehend the information presented on the display 114 before a light timeout or before that information is changed or otherwise removed from the screen.

In one embodiment, still referring to FIG. 1, the device 100 can include an input device 104, output device 106, a processor 122, applications area 180, storage 182 and content analyzer 170. The content analyzer 170 is configured to analyze content on a display, such as display 114 for determining the display item content features. Although the content analyzer 170 is shown separately from the processor 122, it is noted that in other embodiments the content analyzer 170 can be integrated with the processor 122. The components described herein are merely exemplary and are not intended to encompass all components that can be included in the device 100. For example, in one embodiment, the device can comprises a mobile communication device or Internet and application enabled device and include other suitable devices and applications for monitoring application content, acquiring data and providing communication capabilities in such a device. While the input device 104 and output device 106 are shown as separate devices, in one embodiment, the input device 104 and output device 106 can be combined and be part of, and form, the user interface 102.

In one embodiment, the user interface 102 of the disclosed embodiments can be implemented on or in a device that includes a touch screen display or a proximity screen device 112. In alternate embodiments, the aspects of the user interface disclosed herein could be embodied on any suitable device that will display information and allow the selection and activation of applications or system content. The terms “select” and “touch” are generally described herein with respect to a touch screen-display. However, in alternate embodiments, the terms are intended to encompass the required user action with respect to other input devices. For example, with respect to a proximity screen device, it is not necessary for the user to make direct contact in order to select an object or other information. Thus, the above noted terms are intended to encompass that a user only needs to be within the proximity of the device to carry out the desired function. For example, the term “touch” in the context of a proximity screen device, does not necessarily require direct contact, but can include near or close contact, that activates the proximity device.

Similarly, the scope of the intended devices is not limited to single touch or contact devices. Multi-touch devices, where contact by one or more fingers or other pointing devices can navigate on and about the screen are also intended to be encompassed by the disclosed embodiments. Non-touch devices are also intended to be encompassed by the disclosed embodiments. Non-touch devices include, but are not limited to, devices without touch or proximity screens, where navigation on the display is performed through, for example, keys 110 of the system or through voice commands via voice recognition features of the system.

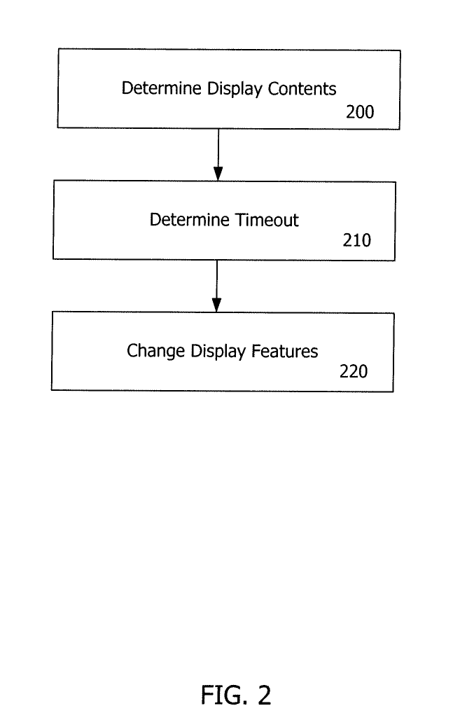

Referring to FIGS. 1 and 2, in one embodiment the system 100 is configured to determine the light timeout 125 based on content presented on the display 114. As described above, the content analyzer 170 is configured to analyze the content of the display 114 for determining the timeout 125 or length of time one or more lights of the display 114 remain illuminated before reducing the intensity of the light(s). In other embodiments, any suitable component of the system 100 can be configured to analyze the display content for determining the light timeout 125. For exemplary purposes only, the disclosed embodiments will be described herein with respect to a backlight of the display 114 but in other embodiments any suitable display feature(s) can be controlled as described herein including, but not limited to, light emitting diodes, keypad lights, portions of a display 114, or individual items presented on the display 114. In one embodiment the device 100 can be configured to cause the backlight to dim in response to the light timeout 125 while in other embodiments the device 100 can cause the backlight to turn off in response to the light timeout 125. In still other embodiments the device 100 can be configured to reduce the intensity of the display 114 in stages (i.e. the backlight is dimmed for a predetermined period of time before the backlight is turned off) or gradually.

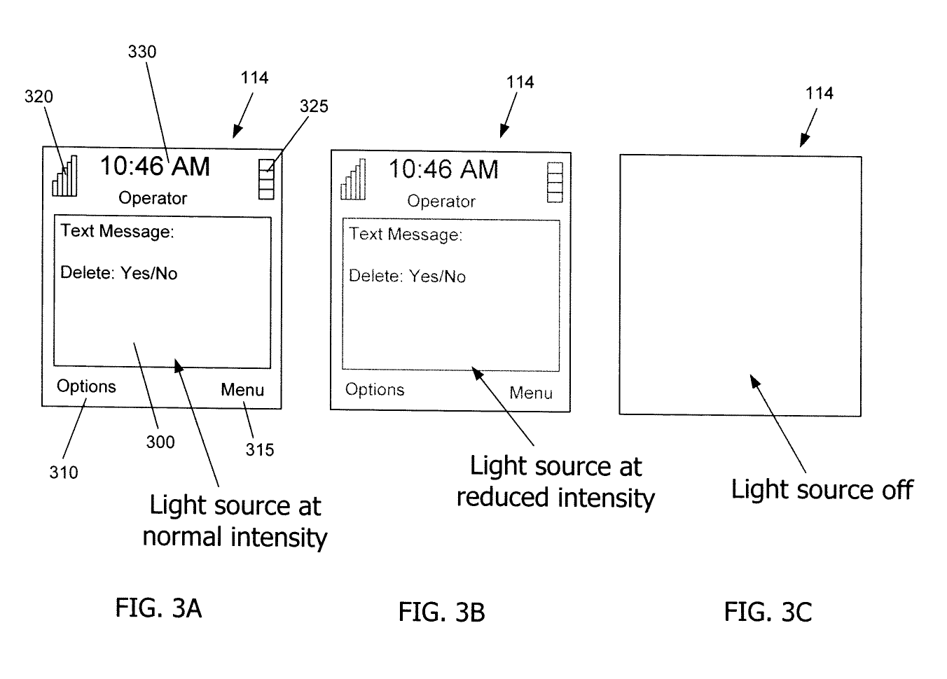

When performing the light timeout 125 the device 100 determines any suitable characteristics of the display content (FIG. 2, Block 200) and determines a length of the light timeout 125 (FIG. 2, Block 210) based on one or more of the characteristics. In one embodiment, the device 100 is configured to determine the amount of content present on the display 114. It is noted that the content can include any suitable information such as text and/or images (moving or still). For example, referring to FIG. 3A, when text is presented on the display 114, the system 100 can determine a length of the message 300 and/or the number of characters included in the message 300. In another embodiment the system 100 can determine the number of characters presented in each of the soft key functions 310, 315 as well as the number of characters presented in the clock 330. In this example, the light timeout 125 is determined based on the total number of characters or length of text presented on the display 114 as a whole. For example, the greater the number of characters presented or the greater the length of the text, the longer the light timeout 125 (e.g. the longer the display 114 stays illuminated).

In one embodiment, the device 100 can be configured to analyze any suitable characteristics of, for example, sentences and/or paragraphs presented on the display 114 when determining and performing the light timeout 125. In one example, the device 100 is configured to determine the complexity of sentences and/or paragraphs presented on the display 114. The complexity of the sentences and/or paragraphs can include, but is not limited to, one or more of a type of statement being made (e.g. exclamation, question, etc.), the difficulty and length of the words used in the sentences and/or paragraphs and the length of the sentences and/or paragraphs. As a non-limiting example, referring to FIG. 3A, the device 100 can be configured to recognize questions, such as the question included in the message 300 and determine the complexity of the question. In this example, the question “Delete: Yes/No” is a relatively simple question to comprehend and the corresponding light timeout 125 may be short in comparison to a lengthier question that requires more than a “yes” or “no” response. In this example, the more complex the question, the longer the length of time before the light intensity of the display 114 changes.

In another embodiment, the density of text presented on the display may also be determined with respect to the light timeout 125. For example, the light timeout 125 is determined to be longer when the density of the text increases. Detecting the text density can include detecting any suitable text characteristics including, but not limited to, detecting a percentage of the display 114 covered by the text, a font size and/or type and the number of lines of text in an area of the display 114.

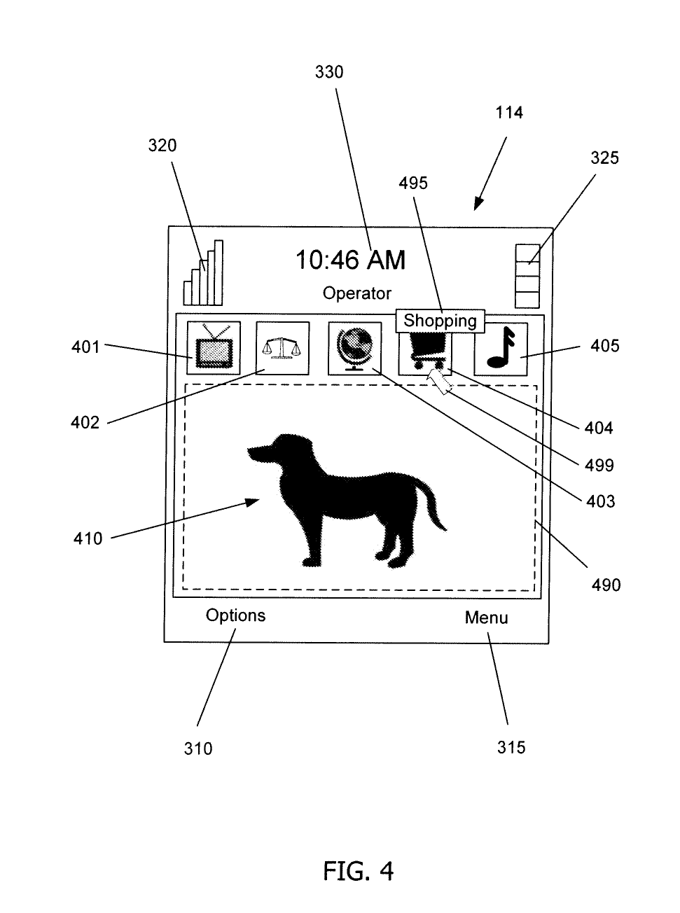

In other embodiments, the device 100 can be configured to calculate a readability index of text presented on the display. Here the more difficult it is to comprehend the information on the display 114, the longer the length of the light timeout. The readability index can be based on any suitable factors including, but not limited to, the length of the words, an arrangement of the words, font size, font type and/or color and text density. The arrangement of the text around images and whether any portion of the text is associated with an image (e.g. a caption) can also be determined when determining the length of the light timeout 125. Considering both the text and associated images when determining the timeout 125 gives the user of the device 100 ample time to comprehend both the images and the text.

Where images, icons or other non-textual graphical representations (collectively referred to as “images”) are presented on the display 114 by themselves or with text, any suitable characteristics of the images can be analyzed to determine the timeout 125. In one embodiment the image characteristics determined by the device can include, but are not limited to, one or more of active pixels, colors, contrasts, and amount of detail and textures presented in the image or icon. For example, referring to FIG. 4, when determining the contents of the display 114 the device 100 can analyze the characteristics of the image 410, the icons 401-405, the signal strength indicator 320 and the battery level indicator 325 in addition to or in lieu of the text based characteristics described above. As one non-limiting example of determining a timeout for an image, the greater the number of active pixels and/or the greater detail in an image, the greater the length of the light timeout 125. Again, as noted above, the display contents are considered as whole when determining the timeout 125 for images.

Referring to FIGS. 3A-3C, when the length of the light timeout 125 is determined in the manner described herein and the time period for the light timeout 125 is expired, the device 100 is configured to change one or more features of the display 114 (FIG. 2, Block 220). In one embodiment, the device 100 is configured to reduce the intensity of for example a backlight of the display 114 as shown in FIG. 3B. Reducing the backlight allows for a conservation of power in the device 100 while still permitting the user to view the information presented on the display. In other embodiments, the device 100 is configured to turn the display off as can be seen in FIG. 3C when the time period for the timeout 125 is expired. In still other embodiments, the light intensity of the display 114 can be reduced in any suitable manner including a gradual decrease in intensity.

In other embodiments, the device 100 can be configured to consider individual areas or features of the display, rather than the display as a whole, when determining the length of the light timeout 125. For example, the display can include active areas/features (e.g. areas of the display that are selected by the user) and inactive areas/features. The inactive areas or features of the display may be reduced in light intensity according to the timeout 125 while the light intensity of the active areas does not change. For example, referring to FIG. 4, if the user is actively using area 490 of the display, one or more of the other display features (e.g. icons 401-405, clock 330, status indicators 320, 325 and soft key functions 310, 315) may be dimmed or the portions of the display corresponding to the other features can be turned off. When determining the light timeout 125 the inactive areas can be considered as a whole or individually. For example, each individual icon 401-405 can be analyzed by the device 100 in the manners described above so that each of the icons 401-405 has it own respective timeout 125. In other examples, where the inactive areas are considered as a whole each of the inactive areas would have the same timeout 125 as determined in the manners described above.

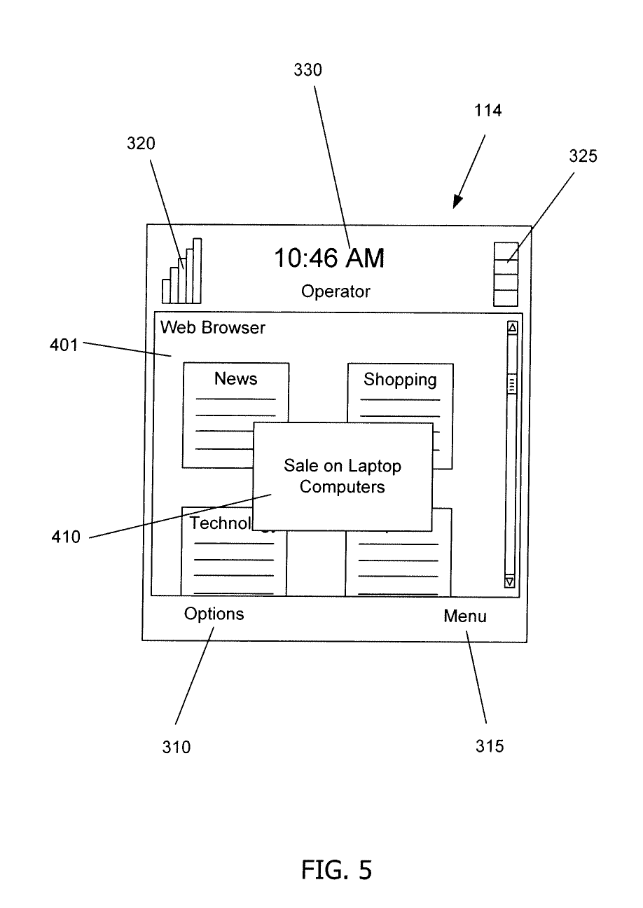

Referring now to FIG. 5, the device 100 can also analyze display content to control other suitable features of the device 100 including, but not limited to, when and for how long information is presented. As can be seen in FIG. 5, a web browser is presented on the display 114. The web page 401 includes text concerning several topics. A pop up advertisement 410 is also shown on the display 114. Generally the pop up advertisements appear as soon as the web page is opened but the disclosed embodiments can be configured so that the appearance of the pop up advertisement 410 is delayed to give the user an opportunity to read the web page 401 contents. In this example, the device 101 can determine the web page contents in the manners described above and calculate a timeout 125 during which the pop up advertisement 410 is precluded from appearing. Upon expiration of the timeout 125 the pop up is allowed to appear and is presented on the display 114. The disclosed embodiments can also control how long the pop up advertisement 410 is presented on the display. For example, the device 100 can determine the contents of the pop advertisement 410 in the manners described above and determine a timeout 125 after the expiration of which the pop up advertisement 410 is removed from the display 114. Although the timeout for presenting or delaying the presentation of information is described with respect to a web page and a pop up advertisement 410, the disclosed embodiments can be equally applied to any suitable information presented on the display 114. For example, generally when software is installed on a device a series of product overviews pertaining to the software are presented while the user is waiting for the installation to be completed. The disclosed embodiments can be applied to these product overviews so that the time each overview is displayed depends on the content in each overview and not a predetermined length of time as is typically the case. In another embodiment the disclosed embodiments can control the length of time help or other informational features are presented to a user. For example referring to FIG. 4 a description of the icons 401-405 such as description 495 may appear on the display when a pointing device or cursor 499 is moved over a respective icon 404. The content of the icon description(s) 495 can be determined and a timeout 125 can be determined for the icon description(s) 495 such that upon expiration of the timeout the icon description is removed from the display 114. In yet another example, the timeout 125 described herein can be applied to information that is scrolled across a display such as in a media player (e.g. mp3 players, etc.). Here as a non-limiting example, file information (e.g. song/video information) can be presented in a scrolling banner. The device 101 can be configured to determine the content of the scrolling banner so that the light timeout occurs after all the information in the banner is presented to the user (e.g. scrolls across the display). As another example, the timeouts 125 described herein can be applied to menu items presented on the display or any other suitable display information that is presented to a user for a limited amount of time.

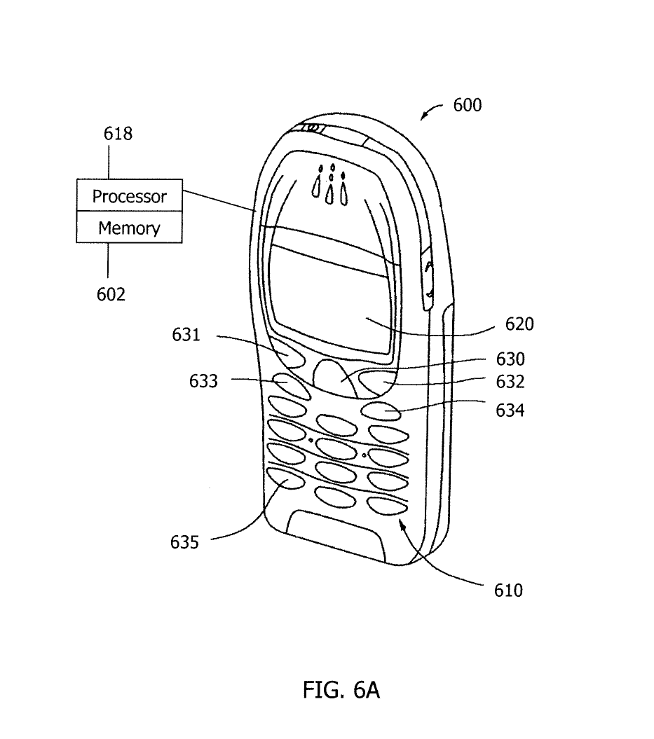

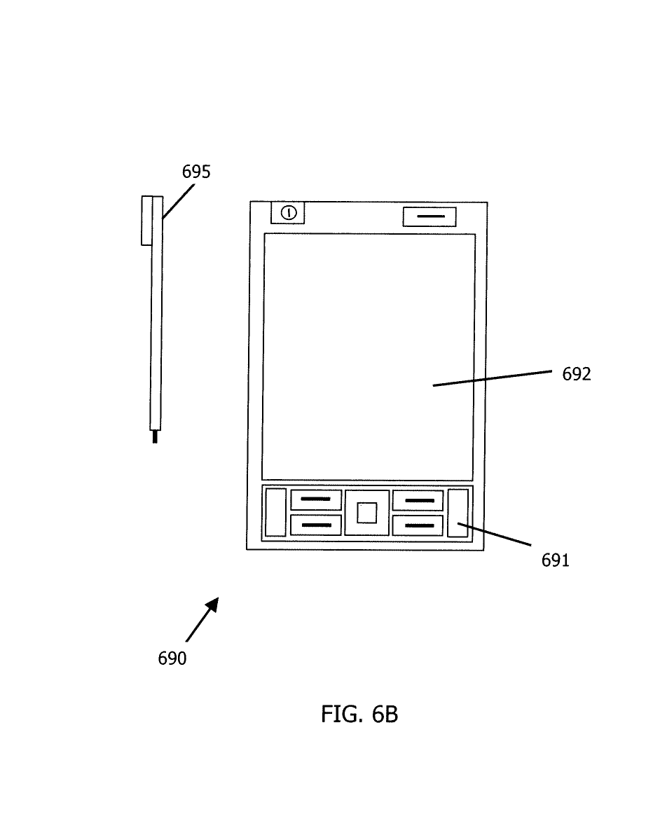

Examples of devices on which aspects of the disclosed embodiments can be practiced are illustrated with respect to FIGS. 6A and 6B. In one embodiment the device 101 can comprise a terminal or mobile communications device 600 that may include a keypad 610 and a display 620. The keypad 610 may include any suitable user input devices such as, for example, a multi-function/scroll key 630, soft keys 631, 632, a call key 633, an end call key 634 and alphanumeric keys 635. The display 620 may be any suitable display, such as for example, a touch screen display or graphical user interface. The display may be integral to the device 600 or the display may be a peripheral display connected to the device 600. A pointing device, such as for example, a stylus, pen or simply the user's finger may be used with the display 620. In alternate embodiments any suitable pointing device may be used. In other alternate embodiments, the display may be a conventional display. In still other alternate embodiments, the display may be any suitable display, such as for example a flat display 114 that is typically made of an liquid crystal display (LCD) with optional back lighting, such as a thin film transistor (TFT) matrix capable of displaying color images.

The device 600 may also include other suitable features such as, for example, a camera, loud speaker, connectivity port or tactile feedback features. The mobile communications device may have a processor 618 connected to the display for processing user inputs and displaying information on the display 620. A memory 602 may be connected to the processor 618 for storing any suitable information and/or applications associated with the mobile communications device 600 such as phone book entries, calendar entries, etc.

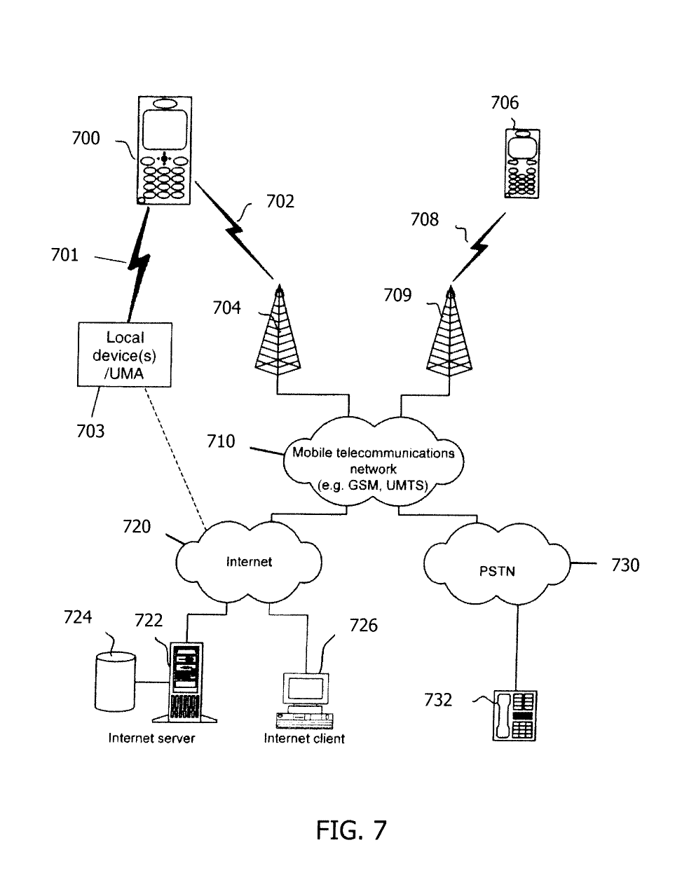

In the embodiment where the device 600 comprises a mobile communications device, the device can be adapted for communication in a telecommunication system, such as that shown in FIG. 7. In such a system, various telecommunications services such as cellular voice calls, worldwide web/wireless application protocol (www/wap) browsing, cellular video calls, data calls, facsimile transmissions, data transmissions, music transmissions, still image transmission, video transmissions, electronic message transmissions and electronic commerce may be performed between the mobile terminal 700 and other devices, such as another mobile terminal 706, a line telephone 732, a personal computer 726 and/or an internet server 722. It is to be noted that for different embodiments of the mobile terminal 700 and in different situations, some of the telecommunications services indicated above may or may not be available. The aspects of the disclosed embodiments are not limited to any particular set of services in this respect.

The mobile terminals 700, 706 may be connected to a mobile telecommunications network 710 through radio frequency (RF) links 702, 708 via base stations 704, 709. The mobile telecommunications network 710 may be in compliance with any commercially available mobile telecommunications standard such as for example global system for mobile communications (GSM), universal mobile telecommunication system (UMTS), digital advanced mobile phone service (D-AMPS), code division multiple access 2000 (CDMA2000), wideband code division multiple access (WCDMA), wireless local area network (WLAN), freedom of mobile multimedia access (FOMA) and time division-synchronous code division multiple access (TD-SCDMA).

The mobile telecommunications network 710 may be operatively connected to a wide area network 720, which may be the Internet or a part thereof. An Internet server 722 has data storage 724 and is connected to the wide area network 720, as is an Internet client computer 726. The server 722 may host a worldwide web/wireless application protocol server capable of serving worldwide web/wireless application protocol content to the mobile terminal 700.

A public switched telephone network (PSTN) 730 may be connected to the mobile telecommunications network 710 in a familiar manner. Various telephone terminals, including the stationary telephone 732, may be connected to the public switched telephone network 730.

The mobile terminal 700 is also capable of communicating locally via a local link 701 to one or more local devices 703. The local link 701 may be any suitable type of link with a limited range, such as for example Bluetooth, a Universal Serial Bus (USB) link, a wireless Universal Serial Bus (WUSB) link, an IEEE 802.11 wireless local area network (WLAN) link, an RS-232 serial link, etc. The above examples are not intended to be limiting, and any suitable type of link may be utilized. The local devices 703 may be antennas and supporting equipment forming a wireless local area network implementing Worldwide Interoperability for Microwave Access (WiMAX, IEEE 802.16), WiFi (IEEE 802.11x) or other communication protocols. The wireless local area network may be connected to the Internet. The mobile terminal 700 may thus have multi-radio capability for connecting wirelessly using mobile communications network 710, wireless local area network or both. Communication with the mobile telecommunications network 710 may also be implemented using WiFi, Worldwide Interoperability for Microwave Access, or any other suitable protocols, and such communication may utilize unlicensed portions of the radio spectrum (e.g. unlicensed mobile access (UMA)). In one embodiment, the device 100 of FIG. 1 can include a communications module that is configured to interact with the system described with respect to FIG. 7.

Although the above embodiments are described as being implemented on and with a mobile communication device, it will be understood that the disclosed embodiments can be practiced on any suitable device incorporating a display, processor, memory and supporting software or hardware. In one embodiment, the system 100 of FIG. 1 may be for example, a personal digital assistant (PDA) style device 690 illustrated in FIG. 6B. The personal digital assistant 690 may have a keypad 691, a touch screen display 692 and a pointing device 695 for use on the touch screen display 692. In still other alternate embodiments, the device may be a personal computer, a tablet computer, touch pad device, Internet tablet, a laptop or desktop computer, a mobile terminal, a cellular/mobile phone, a multimedia device, media player, a personal communicator, a television or television set top box, or any other suitable device capable of containing for example a display 114 shown in FIG. 1, and supported electronics such as the processor 618 and memory 602 of FIG. 6A.

The user interface 102 of FIG. 1 can also include menu systems 124 associated with the timeout 125. The menu system 124 can provide for the selection of different tools and application options related to the applications or programs running on the system 100 such as the timeout 125. In one embodiment, the menu system 124 may provide for the selection of features associated with the light timeout 125 such as, for example, user specified criteria or any suitable setting features including, but not limited to, the settable features described herein. In one embodiment the user specified criteria can include a number of words per minute the user can read. In other embodiments the menu system 124 can include a series of tests that can be used to determine the user's ability to comprehend text based and graphics based data. One or more the user specified criteria and test results can be used by the device 100 when determining the timeout.

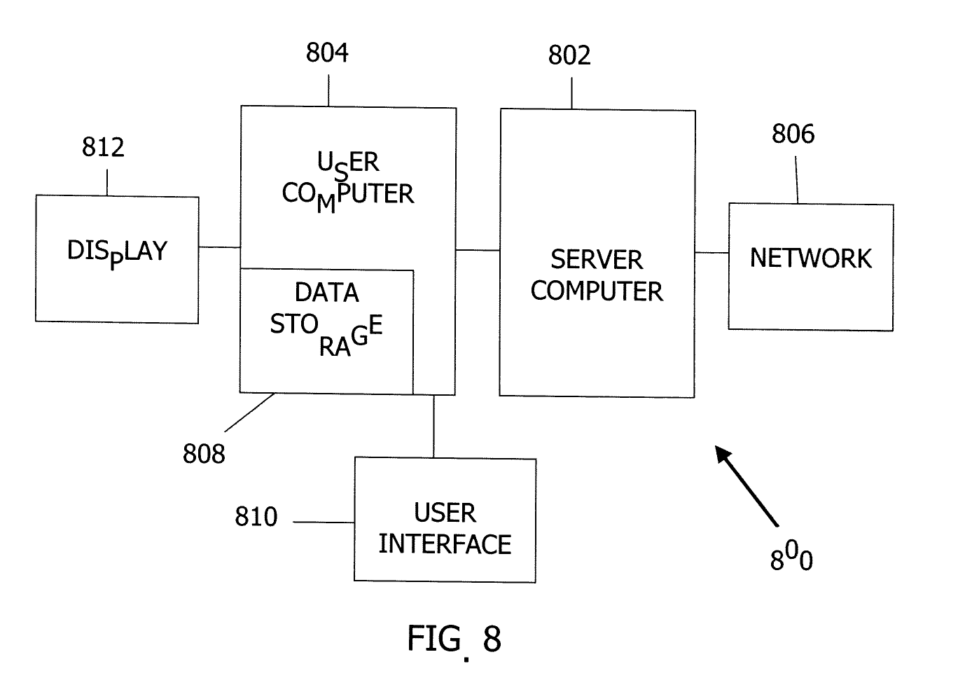

The disclosed embodiments may also include software and computer programs incorporating the process steps and instructions described above that are executed in different computers. FIG. 8 is a block diagram of one embodiment of a typical apparatus 800 incorporating features that may be used to practice aspects of the invention. The apparatus 800 can include computer readable program code means for carrying out and executing the process steps described herein. As shown, a computer system 802 may be linked to another computer system 804, such that the computers 802 and 804 are capable of sending information to each other and receiving information from each other. In one embodiment, computer system 802 could include a server computer adapted to communicate with a network 806. Computer systems 802 and 804 can be linked together in any conventional manner including, for example, a modem, wireless, hard wire connection, or fiber optic link. Generally, information can be made available to both computer systems 802 and 804 using a communication protocol typically sent over a communication channel or through a dial-up connection on an integrated services digital network (ISDN) line. Computers 802 and 804 are generally adapted to utilize program storage devices embodying machine-readable program source code, which is adapted to cause the computers 802 and 804 to perform the method steps, disclosed herein. The program storage devices incorporating aspects of the invention may be devised, made and used as a component of a machine utilizing optics, magnetic properties and/or electronics to perform the procedures and methods disclosed herein. In alternate embodiments, the program storage devices may include magnetic media such as a diskette or computer hard drive, which is readable and executable by a computer. In other alternate embodiments, the program storage devices could include optical disks, read-only-memory (“ROM” floppy disks and semiconductor materials and chips.

Computer systems 802 and 804 may also include a microprocessor for executing stored programs. Computer 804 may include a data storage device 808 on its program storage device for the storage of information and data. The computer program or software incorporating the processes and method steps incorporating aspects of the invention may be stored in one or more computers 802 and 804 on an otherwise conventional program storage device. In one embodiment, computers 802 and 804 may include a user interface 810, and a display interface 812 from which aspects of the invention can be accessed. The user interface 810 and the display interface 812 can be adapted to allow the input of queries and commands to the system, as well as present the results of the commands and queries.

The embodiments described herein provide a timeout determination based on display content features. The display content features are analyzed in such a way so as to provide a user of the device adequate time to read or view the content while at the same time optimizing power consumption of the device.

It is noted that the embodiments described herein can be used individually or in any combination thereof. It should be understood that the foregoing description is only illustrative of the embodiments. Various alternatives and modifications can be devised by those skilled in the art without departing from the embodiments. Accordingly, the present embodiments are intended to embrace all such alternatives, modifications and variances that fall within the scope of the appended claims.

What is claimed is:

1. A method comprising:
automatically determining one or more characteristics of displayed content; and
dynamically adjusting a timeout period in dependence on the one or more characteristics.

2. The method of claim 1, wherein the one or more characteristics include one or more of text based characteristics and graphic based characteristics.

3. The method of claim 1, further comprising adjusting an intensity of the display upon expiration of the timeout period.

4. The method of claim 1, wherein the timeout period delays a presentation of information on a display.

5. The method of claim 1, further comprising presenting information on a display for a length of the timeout period.

6. The method of claim 1, wherein the displayed content includes one or more of text and images.

7. A computer program product embodied in a memory of a device comprising:
computer readable program code embodied in a computer readable medium for executing the method of claim 1.

8. The computer program product of claim 7, wherein the one or more characteristics include one or more of text based characteristics and graphic based characteristics.

9. The computer program product of claim 7, further comprising computer readable program code embodied in a computer readable medium for adjusting an intensity of the display upon expiration of the timeout period.

10. The computer program product of claim 7, wherein the timeout period delays a presentation of information on a display.

11. The computer program product of claim 7, further comprising computer readable program code embodied in a computer readable medium for presenting information on a display for a length of the timeout period.

12. An apparatus comprising:
a processor; and
a display connected to the processor;
wherein the processor is configured to:
automatically determine one or more characteristics content presented on the display; and
dynamically adjust a timeout period in dependence on the one or more characteristics.

13. The apparatus of claim 12, wherein the one or more characteristics include one or more of text based characteristics and graphic based characteristics.

14. The apparatus of claim 12, wherein the processor is further configured to adjust an intensity of the display upon expiration of the timeout period.

15. The apparatus of claim 12, wherein the processor is further configured to delay a presentation of information on a display for a length of the timeout period.

16. The apparatus of claim 12, wherein the processor is further configured to present information on a display for a length of the timeout period.

17. The apparatus of claim 12, wherein the content presented on the display includes one or more of text and images.

18. The apparatus of claim 12, wherein the apparatus comprises a mobile communication device.

19. A user interface comprising:
an input device;
a display; and
a processor connected to the input and display, the processor being configured to:
automatically determine one or more characteristics content presented on the display; and
dynamically adjust a timeout period in dependence on the one or more characteristics.

20. The user interface of claim 19, wherein the one or more characteristics include one or more of text based characteristics and graphic based characteristics.

21. The user interface of claim 19, wherein the processor is further configured to adjust an intensity of the display upon expiration of the timeout period.

22. The user interface of claim 19, wherein the processor is further configured to delay a presentation of information on a display for a length of the timeout period.

23. The user interface of claim 19, wherein the processor is further configured to present information on a display for a length of the timeout period.
